(19) United States
(12) Patent Application Publication
(10) Pub. No.: US 2026/0222136 A1
(43) Pub. Date: Jul. 30, 2026

(54) Wireless communication method and wireless communication device for enhanced multi-resource unit puncturing pattern transmission

(71) Applicant: MEDIATEK INC., Hsinchu City (TW)

(72) Inventors: Sin-Yuan Huang, Hsinchu City (TW); Cheng-Yi Chang, Hsinchu City (TW); Wen-Hsien Chiu, Hsinchu City (TW); Hung-Tao Hsieh, Hsinchu City (TW); Yi-Hsiang Lai, Hsinchu City (TW)

(73) Assignee: MEDIATEK INC., Hsinchu City (TW)

(21) Appl. No.: 19/457,197

(22) Filed: Jan. 23, 2026

Related U.S. Application Data
(60) Provisional application No. 63/749,017, filed on Jan. 24, 2025.

(51) Int. Cl. H04L 5/00; H04L 1/00

(52) U.S. Cl. CPC H04L 5/0044; H04L 1/0011; H04L 1/0069

(57) ABSTRACT

A wireless communication device and method for transmitting and receiving a physical layer protocol data unit (PPDU) using enhanced multi-resource unit (MRU) puncturing patterns are provided. The method includes selecting an enhanced MRU puncturing pattern that identifies punctured subchannels within a channel bandwidth, wherein the enhanced MRU puncturing pattern supports finer granularity puncturing and discrete puncturing of multiple non-contiguous subchannels. The wireless communication device generates a PPDU preamble carrying signaling information that includes one or more validate bits indicating use of the enhanced MRU puncturing pattern and puncturing pattern information identifying the selected pattern. A receiving device extracts the signaling information, identifies the puncturing pattern, and decodes the PPDU payload based on the identified puncturing pattern.

### CROSS REFERENCE TO RELATED APPLICATIONS

This application claims the benefit of U.S. Provisional Application No. 63/749,017, filed on January 24th, 2025. The content of the application is incorporated herein by reference.

### BACKGROUND

Modern Wi-Fi^{®} systems use wide channels, such as 80 MHz, 160 MHz, and 320 MHz, to increase data throughput. Wi-Fi^{®} is a registered trademark of the Wi-Fi Alliance^{®}. In dense deployments with many nearby networks, interference may affect only part of a wide channel. The interference may occupy a single small frequency block or several separated blocks.

A Wi-Fi device can apply Wi-Fi channel puncturing to avoid interference by not transmitting on the interfered subchannels while still transmitting on the remaining subchannels. This allows the device to continue sending data on the subchannels that are not affected by interference.

Current Wi-Fi puncturing standards define only a limited set of allowed puncturing patterns and may rely on coarse granularity, which can be inefficient in typical interference scenarios. For example, if interference affects only 20 MHz inside a 320 MHz channel, the puncturing patterns defined in existing standards may require disabling a larger portion, such as 40 MHz. This wastes usable spectrum and reduces throughput. The standard defined patterns may also limit how many separated interfered blocks can be avoided at the same time.

### SUMMARY

An embodiment of the present disclosure provides a wireless communication method for transmitting a physical layer protocol data unit (PPDU) with an enhanced multi-resource unit (MRU) puncturing pattern. The wireless communication method comprises determining, by a wireless communication device, the enhanced MRU puncturing pattern for transmission; generating, by the wireless communication device, a preamble of the PPDU; and transmitting, by the wireless communication device, the PPDU including the preamble to a receiving device. The preamble includes signaling information configured to indicate that the enhanced MRU puncturing pattern is used and to identify the enhanced MRU puncturing pattern. The enhanced MRU puncturing pattern indicates at least one of: (i) for a channel bandwidth of 80 MHz or 160 MHz, at least two punctured subchannels; or (ii) for a channel bandwidth greater than or equal to 320 MHz, at least one of: exactly one punctured subchannel having a bandwidth of 20 MHz; at least two punctured subchannels having the same bandwidth; exactly two punctured subchannels having different bandwidths, wherein one of the exactly two punctured subchannels has a bandwidth of 20 MHz; exactly two punctured subchannels having bandwidths of 40 MHz and 80 MHz, wherein the 80 MHz punctured subchannel is not located at either the lowest frequency end or the highest frequency end of the channel bandwidth; or at least three punctured subchannels.

Another embodiment of the present disclosure provides a wireless communication method for receiving a physical layer protocol data unit (PPDU). The wireless communication method comprises receiving, by a wireless communication device, the PPDU from a transmitting device, wherein the PPDU is transmitted over a channel bandwidth comprising a plurality of subchannels; extracting signaling information from a preamble of the PPDU; determining, based on the signaling information, that an enhanced multi-resource unit (MRU) puncturing pattern is used for the PPDU; identifying the enhanced MRU puncturing pattern based on the signaling information; and decoding payload data from the PPDU based on the identified enhanced MRU puncturing pattern.

Another embodiment of the present disclosure provides a wireless communication device. The wireless communication device comprises a transceiver and a processor. The transceiver is configured to transmit and receive physical layer protocol data units (PPDUs) over a wireless channel. The processor is coupled to the transceiver, and configured to determine an enhanced multi-resource unit (MRU) puncturing pattern for transmission, generate a preamble for inclusion in a PPDU, and control the transceiver to transmit the PPDU including the preamble. The preamble includes signaling information configured to indicate that the enhanced MRU puncturing pattern is used and to identify the enhanced MRU puncturing pattern. The enhanced MRU puncturing pattern indicates at least one of: (i) for a channel bandwidth of 80 MHz or 160 MHz, at least two punctured subchannels; or (ii) for a channel bandwidth greater than or equal to 320 MHz, at least one of: exactly one punctured subchannel having a bandwidth of 20 MHz; at least two punctured subchannels having the same bandwidth; exactly two punctured subchannels having different bandwidths, wherein one of the exactly two punctured subchannels has a bandwidth of 20 MHz; exactly two punctured subchannels having bandwidths of 40 MHz and 80 MHz, wherein the 80 MHz punctured subchannel is not located at either the lowest frequency end or the highest frequency end of the channel bandwidth; or at least three punctured subchannels.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a wireless communication system including wireless communication devices configured to transmit and receive physical layer protocol data units (PPDUs) with enhanced multi-resource unit (MRU) puncturing patterns, in accordance with some embodiments of the present disclosure.

FIG. 2 is a schematic diagram illustrating a PPDU structure in which a preamble carries signaling information including a universal signal (U-SIG) field, in accordance with some embodiments of the present disclosure.

FIG. 3 is a schematic diagram illustrating a PPDU structure in which a preamble carries signaling information distributed across a universal signal (U-SIG) field and a second signaling field, in accordance with some embodiments of the present disclosure.

FIG. 4 is a schematic diagram illustrating enhanced MRU puncturing patterns for a channel bandwidth of 320 MHz with exactly one 20 MHz punctured subchannel, in accordance with some embodiments of the present disclosure.

FIG. 5 is a schematic diagram illustrating enhanced MRU puncturing patterns for channel bandwidths of 80 MHz and 160 MHz with at least two punctured subchannels, in accordance with some embodiments of the present disclosure.

FIG. 6 is a schematic diagram illustrating enhanced MRU puncturing patterns for a channel bandwidth of 160 MHz with at least three punctured subchannels, in accordance with some embodiments of the present disclosure.

FIG. 7 is a schematic diagram illustrating enhanced MRU puncturing patterns for a channel bandwidth of 320 MHz with exactly two punctured subchannels, in accordance with some embodiments of the present disclosure.

FIG. 8 is a schematic diagram illustrating enhanced MRU puncturing patterns for a channel bandwidth of 320 MHz with at least three punctured subchannels, in accordance with some embodiments of the present disclosure.

FIG. 9 is a schematic diagram illustrating enhanced MRU puncturing patterns for a channel bandwidth of 325 MHz in the 5 GHz band, in accordance with some embodiments of the present disclosure.

FIG. 10 is a schematic diagram illustrating enhanced MRU puncturing patterns for a channel bandwidth of 320 MHz showing a primary 160 MHz segment (P160) and a secondary 160 MHz segment (S160), in accordance with some embodiments of the present disclosure.

### DETAILED DESCRIPTION

The following description sets forth exemplary embodiments and does not limit the scope of the appended claims. Features described in connection with one embodiment may be combined with features of other embodiments. Reference throughout this specification to "one embodiment," "an embodiment," "certain embodiments," or similar language means that a particular feature, structure, or characteristic described in connection with the embodiment may be included in at least one embodiment. Thus, appearances of the phrases "in one embodiment," "in an embodiment," "In some embodiments," and similar language throughout this specification may, but do not necessarily, all refer to the same embodiment.

Reference will now be made in detail to embodiments, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details.

As used herein, the term "EHT" refers generally to Extremely High Throughput and is defined according to the IEEE 802.11be standards. The term "UHR" refers generally to Ultra-High Reliability and is defined according to the IEEE 802.11bn standards. The term "PPDU" refers generally to a physical layer protocol data unit, which is a data unit transmitted over a wireless channel. The term "second signaling field" refers generally to a signaling field that follows the universal signal (U-SIG) field in the preamble, which may include an extremely high throughput signal (EHT-SIG) field or an ultra-high reliability signal (UHR-SIG) field depending on the applicable wireless communication standard.

As used herein, the term "puncturing" refers generally to preamble puncturing in wireless communication systems conforming to IEEE 802.11 standards (e.g., IEEE 802.11be, IEEE 802.11bn, or subsequent standards), wherein one or more 20 MHz subchannels within a channel bandwidth are excluded from a physical layer protocol data unit (PPDU) transmission. In certain implementations, an access point (AP) indicates punctured subchannels through a bitmap subfield (e.g., a Disabled Subchannel Bitmap subfield) in an operation element. In the bitmap, each bit corresponds to a 20 MHz subchannel, and a bit value of 1 indicates that the corresponding 20 MHz subchannel is punctured and may not be used by any PPDU transmitted within the operating channel. A "punctured subchannel" refers to a 20 MHz subchannel that is indicated as disabled and is excluded from data transmission, typically to mitigate interference from overlapping basic service sets (OBSS). An "active subchannel" or "nonpunctured subchannel" refers to a subchannel that is used for data transmission.

As used herein, the term "resource unit" or "RU" refers generally to a set of contiguous subcarriers (tones) allocated for data transmission in orthogonal frequency-division multiple access (OFDMA) or non-OFDMA transmissions. Resource units are defined with various sizes corresponding to different numbers of tones, such as 26-tone RU, 52-tone RU, 106-tone RU, 242-tone RU (corresponding to approximately 20 MHz), 484-tone RU (corresponding to approximately 40 MHz), 996-tone RU (corresponding to approximately 80 MHz), and 2×996-tone RU (corresponding to approximately 160 MHz). For a 320 MHz channel bandwidth without puncturing, the entire bandwidth may be allocated as a 4×996-tone RU.

As used herein, the term "multi-resource unit" or "MRU" refers generally to a configuration where multiple resource units are combined to form a single allocation spanning noncontiguous frequency resources when puncturing is applied. When a puncturing pattern is applied to a channel bandwidth, the resulting allocation forms an MRU comprising multiple resource units (RUs). Examples of MRUs include: 484+242-tone MRU (for 80 MHz with one 20 MHz punctured), 996+484-tone MRU (for 160 MHz with 40 MHz punctured), 996+484+242-tone MRU (for 160 MHz with one 20 MHz punctured), 3×996-tone MRU (for 320 MHz with 80 MHz punctured), and 3×996+484-tone MRU (for 320 MHz with 40 MHz punctured).

As used herein, the term "enhanced MRU puncturing pattern" refers generally to puncturing patterns disclosed in the present disclosure that provide greater flexibility and finer granularity compared to puncturing patterns defined in existing wireless communication standards. For example, in IEEE 802.11be, the puncturing granularity for 20 MHz, 40 MHz, 80 MHz, and 160 MHz PPDU bandwidths is 20 MHz, while the puncturing granularity for 320 MHz PPDU bandwidth is limited to 40 MHz. Additionally, existing standards may define only a limited set of puncturing patterns for each channel bandwidth. The enhanced MRU puncturing patterns disclosed herein address these limitations by providing: (1) finer granularity puncturing for wider channel bandwidths (e.g., 320 MHz or greater) using 20 MHz puncturing units instead of 40 MHz or larger puncturing units; (2) additional discrete puncturing patterns supporting multiple non-contiguous punctured subchannels beyond those defined in existing standards; and (3) flexible puncturing configurations that accommodate complex interference scenarios with multiple interference sources of varying bandwidths. The enhanced MRU puncturing patterns are applicable to wireless communication systems conforming to IEEE 802.11be, IEEE 802.11bn, or subsequent IEEE 802.11 standards.

As used herein, the term "puncturing pattern information" refers generally to signaling information carried in the preamble of a PPDU that indicates a puncturing pattern. In certain implementations, the puncturing pattern information is carried in a multi-bit field (e.g., a 5-bit Puncturing pattern information field) located within a signaling field of the preamble (e.g., the U-SIG-2 symbol of the U-SIG field). Each value of the puncturing pattern information field corresponds to a specific puncturing pattern and an associated resource unit (RU) or multi-resource unit (MRU) allocation. In the puncturing pattern notation, a "1" denotes a nonpunctured subchannel and an "x" denotes a punctured subchannel, with parameters ordered from left to right corresponding to subchannels in order of increasing frequency.

As used herein, the term "validate bit" refers generally to a reserved bit field in a signaling field of a PPDU preamble that is used for forward compatibility. In certain implementations, validate bits in the U-SIG field include bit positions such as B25 of the U-SIG-1 symbol, B2 of the U-SIG-2 symbol, and B8 of the U-SIG-2 symbol, each set to a predetermined value (e.g., 1). According to embodiments of the present disclosure, one or more validate bits are repurposed to indicate that an enhanced MRU puncturing pattern is used, thereby enabling backward-compatible signaling of enhanced puncturing patterns to legacy STAs.

In the present disclosure, a bandwidth of 20 MHz may be interchangeably denoted as BW20 or 20 MHz, a bandwidth of 40 MHz may be interchangeably denoted as BW40 or 40 MHz, a bandwidth of 80 MHz may be interchangeably denoted as BW80 or 80 MHz, a bandwidth of 160 MHz may be interchangeably denoted as BW160 or 160 MHz, and a bandwidth of 320 MHz may be interchangeably denoted as BW320 or 320 MHz.

The terms "channel" and "subchannel" are used interchangeably herein and may refer to a narrower bandwidth (e.g., 20 MHz, 40 MHz, 80 MHz) within a wider operating bandwidth (e.g., 80 MHz, 160 MHz, 320 MHz).

The term "station" or "STA" refers to an electronic device capable of sending and receiving data in a wireless local area network (WLAN) compliant with IEEE 802.11 standards. A STA may operate as an access point (AP) or as a non-access point station (non-AP STA). An AP is a wireless communication device that provides network connectivity to other devices. A non-AP STA is a wireless communication device that connects to a network through an AP.

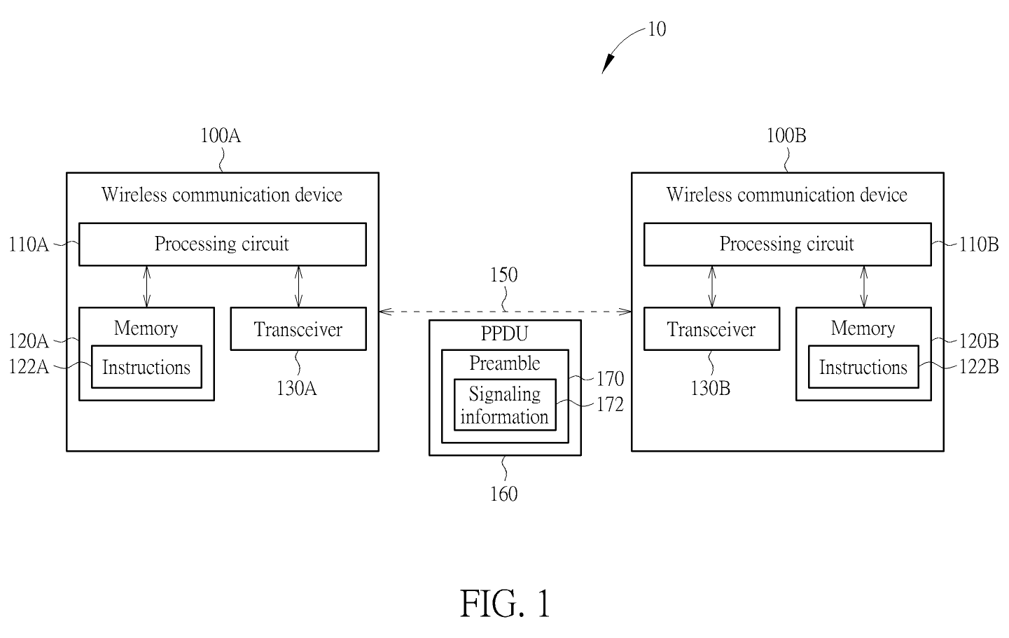

FIG. 1 illustrates a wireless communication system 10 according to an embodiment. The wireless communication system 10 comprises a wireless communication device 100A and a wireless communication device 100B configured to communicate over a wireless channel 150. In some embodiments, the wireless communication device 100A may operate as a transmitting device, and the wireless communication device 100B may operate as a receiving device. In other embodiments, the roles may be reversed, or both devices may operate as both transmitting and receiving devices.

In some embodiments, the wireless communication device 100A may be a non-AP STA and the wireless communication device 100B may be an AP. In other embodiments, the wireless communication device 100A may be an AP and the wireless communication device 100B may be a non-AP STA. In other embodiments, the wireless communication device 100A may be a first multi-link device (MLD) and the wireless communication device 100B may be a second MLD. When multi-link devices are involved, the wireless communication device 100A and the wireless communication device 100B may communicate via multiple links simultaneously or alternatively, and the enhanced MRU puncturing pattern methods disclosed herein may be applied to one or more of the multiple links. In some embodiments, the wireless communication device 100A and the wireless communication device 100B are wireless communication devices compliant with IEEE 802.11bn (Wi-Fi 8) or subsequent wireless communication standards.

The wireless communication device 100A comprises a processing circuit 110A, a memory 120A coupled to the processing circuit 110A, and a transceiver 130A. The memory 120A stores instructions 122A that, when executed by the processing circuit 110A, cause the wireless communication device 100A to perform the methods disclosed in the present disclosure. Similarly, the wireless communication device 100B comprises a processing circuit 110B, a memory 120B coupled to the processing circuit 110B, and a transceiver 130B. The memory 120B stores instructions 122B that, when executed by the processing circuit 110B, cause the wireless communication device 100B to perform the methods disclosed in the present disclosure.

The processing circuits 110A and 110B may include one or more central processing units (CPUs), digital signal processors (DSPs), application-specific integrated circuits (ASICs), field-programmable gate arrays (FPGAs), or other processing devices configured to execute instructions. The memories 120A and 120B may include volatile memory such as random access memory (RAM), non-volatile memory such as flash memory or read-only memory (ROM), or combinations thereof.

The transceivers 130A and 130B are coupled to the processing circuits 110A and 110B, respectively, and are configured to transmit and receive wireless signals over radio frequency (RF) channels. In some embodiments, the transceiver 130A or 130B includes an RF front end and baseband circuitry for IEEE 802.11 operation. For example, the transmit path may include one or more transmit chains with frequency translation to an RF channel and power amplification, and the receive path may include one or more receive chains with low-noise amplification, channel selection filtering, and analog-to-digital conversion, with associated gain control and impairment compensation. The transceiver 130A or 130B may interface with one or more antennas and may support single-input single-output (SISO) or multiple-input multiple-output (MIMO) operation (including multi-link operation in some embodiments), and the processing circuit 110A or 110B may control the transceiver 130A or 130B and exchange frame data via registers, interrupts, and/or direct memory access (DMA)-backed buffers.

In operation, the wireless communication device 100A transmits a physical layer protocol data unit (PPDU) 160 to the wireless communication device 100B over the wireless channel 150. As depicted in FIG. 1, the PPDU 160 includes a preamble 170 containing signaling information 172. The signaling information 172 is configured to indicate that an enhanced MRU puncturing pattern is used and to identify the enhanced MRU puncturing pattern used for the transmission.

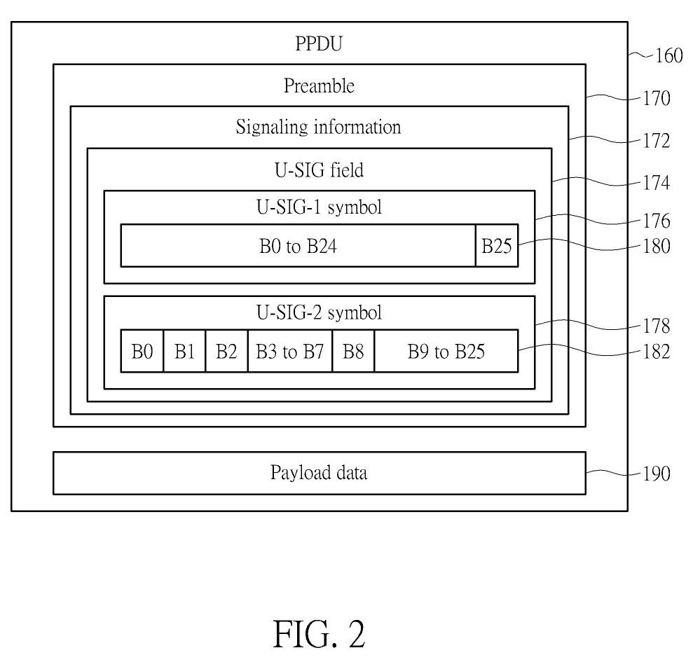

FIG. 2 illustrates a structure of the PPDU 160 according to an embodiment of the present disclosure. The PPDU 160 comprises the preamble 170 and payload data 190. The preamble 170 comprises the signaling information 172 configured to indicate that an enhanced MRU puncturing pattern is used and to identify the enhanced MRU puncturing pattern.

In the embodiment of FIG. 2, the signaling information 172 includes a universal signal (U-SIG) field 174. The U-SIG field 174 includes a first U-SIG symbol (U-SIG-1) 176 and a second U-SIG symbol (U-SIG-2) 178. The U-SIG-1 symbol 176 includes a first plurality of bits 180 spanning bit positions B0 to B25. The U-SIG-2 symbol 178 includes a second plurality of bits 182 spanning bit positions B0 to B25.

According to embodiments of the present disclosure, one or more validate bits within the U-SIG field 174 may be set to a predetermined value to indicate that an enhanced MRU puncturing pattern is used. In some embodiments, the at least one validate bit includes one or more validate bits selected from: bit position B25 of the first plurality of bits 180 of the U-SIG-1 symbol 176, bit position B2 of the second plurality of bits 182 of the U-SIG-2 symbol 178, and bit position B8 of the second plurality of bits 182 of the U-SIG-2 symbol 178.

In some embodiments, when a validate bit (e.g., B25 of the first plurality of bits 180 of the U-SIG-1 symbol 176 or B8 of the second plurality of bits 182 of the U-SIG-2 symbol 178) is set to a first value (e.g., 0), this indicates that an enhanced MRU puncturing pattern is used. When the validate bit is set to a second value (e.g., 1), this indicates that a standard puncturing pattern defined in existing standards is used.

The second plurality of bits 182 of the U-SIG-2 symbol 178 further includes puncturing pattern information at bit positions B3 to B7. The puncturing pattern information (5 bits) is configured to identify which of a plurality of enhanced MRU puncturing patterns is used for the PPDU 160. In some embodiments, the 5-bit puncturing pattern information can represent up to 32 different puncturing patterns.

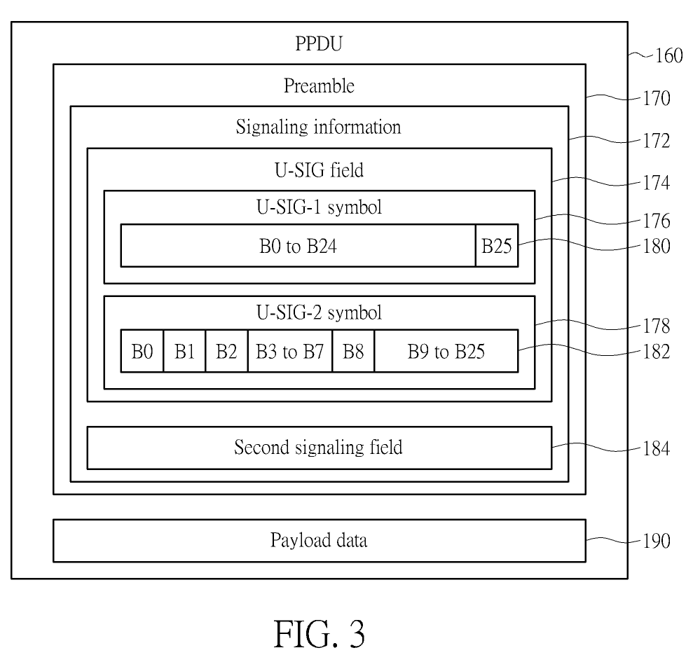

FIG. 3 illustrates a structure of the PPDU 160 according to another embodiment of the present disclosure. In addition to the elements described with reference to FIG. 2, the embodiment of FIG. 3 includes a second signaling field 184 within the preamble 170. The second signaling field 184 includes an extremely high throughput signal (EHT-SIG) field or an ultra-high reliability signal (UHR-SIG) field. In some embodiments, the EHT-SIG field is used for wireless communication systems conforming to IEEE 802.11be (Wi-Fi 7), while the UHR-SIG field is used for wireless communication systems conforming to IEEE 802.11bn (Wi-Fi 8) or subsequent standards.

In some embodiments, the signaling information 172 is distributed across the U-SIG field 174 and the second signaling field 184. This configuration allows for additional signaling capacity to support a larger number of enhanced MRU puncturing patterns or to provide more detailed puncturing information. For example, the U-SIG field 174 may indicate that an enhanced MRU puncturing pattern is used and provide a partial indication of the pattern, while the second signaling field 184 provides additional information to fully identify the specific pattern. Compared to the embodiment of FIG. 2, where the 5-bit puncturing pattern information in the U-SIG field 174 can represent up to 32 different puncturing patterns, the embodiment of FIG. 3 can define a greater number of different puncturing patterns by utilizing additional bits in the second signaling field 184. For example, if the second signaling field 184 provides additional N bits for puncturing pattern indication, the signaling information 172 can represent up to (32×2^{N}) different puncturing patterns, thereby accommodating more complex and diverse puncturing configurations.

According to embodiments of the present disclosure, enhanced MRU puncturing patterns extend beyond puncturing patterns defined in existing standards to provide greater flexibility in spectrum utilization. The enhanced MRU puncturing patterns include patterns for various channel bandwidths including 80 MHz, 160 MHz, and 320 MHz (or greater).

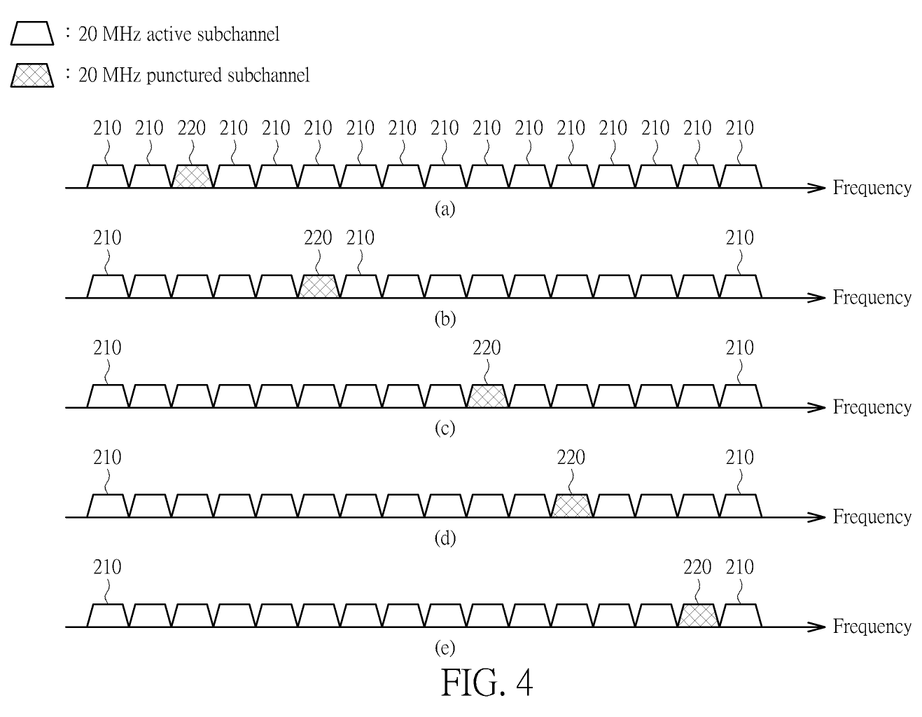

In FIGS. 4 through 10, active subchannels 210 are illustrated using a first visual representation (e.g., unshaded or lighter shading), and punctured subchannels are illustrated using different visual representations based on their bandwidth: 20 MHz punctured subchannels 220, 40 MHz punctured subchannels 240, and 80 MHz punctured subchannels 280.

It should be understood that the positions of the punctured subchannels 220, 240, 280 and the 5 MHz unavailable subchannel 205 within the channel bandwidth as depicted in FIGS. 4 through 10 are provided for illustrative purposes only and are not intended to limit the scope of the present disclosure. In various embodiments, the punctured subchannels 220, 240, 280 may be located at any suitable positions within the channel bandwidth depending on the locations of interference sources. Similarly, the 5 MHz unavailable subchannel 205 may be located at different positions within the channel bandwidth depending on regulatory requirements applicable to the operating frequency band.

FIG. 4 illustrates enhanced MRU puncturing patterns for a channel bandwidth of 320 MHz with exactly one punctured subchannel having a bandwidth of 20 MHz, according to embodiments of the present disclosure. As depicted in FIG. 4, the 320 MHz channel bandwidth includes sixteen 20 MHz subchannels. This enhanced MRU puncturing pattern may be denoted as "320-20" indicating a 320 MHz channel bandwidth with a single 20 MHz punctured subchannel.

In the embodiments of the sections (a) through (e) of FIG. 4, exactly one 20 MHz punctured subchannel 220 is located at different positions within the 320 MHz channel bandwidth, while the remaining subchannels are active subchannels 210. The 20 MHz punctured subchannel 220 may be located at any of the sixteen 20 MHz subchannel positions within the 320 MHz channel bandwidth. When a single 20 MHz subchannel is punctured, the remaining fifteen 20 MHz active subchannels 210 form a multi-resource unit (MRU).

This enhanced MRU puncturing pattern provides advantages over existing standards, which may only support puncturing at 40 MHz granularity for 320 MHz channel bandwidths. By supporting 20 MHz granularity puncturing, the enhanced MRU puncturing pattern enables more efficient spectrum utilization when interference affects only a 20 MHz portion of the channel bandwidth. For example, if a 20 MHz interference source is present, the enhanced MRU puncturing pattern allows the wireless communication device to puncture only the affected 20 MHz subchannel rather than a larger 40 MHz subchannel, thereby recovering 20 MHz of additional usable bandwidth and the associated resource unit capacity.

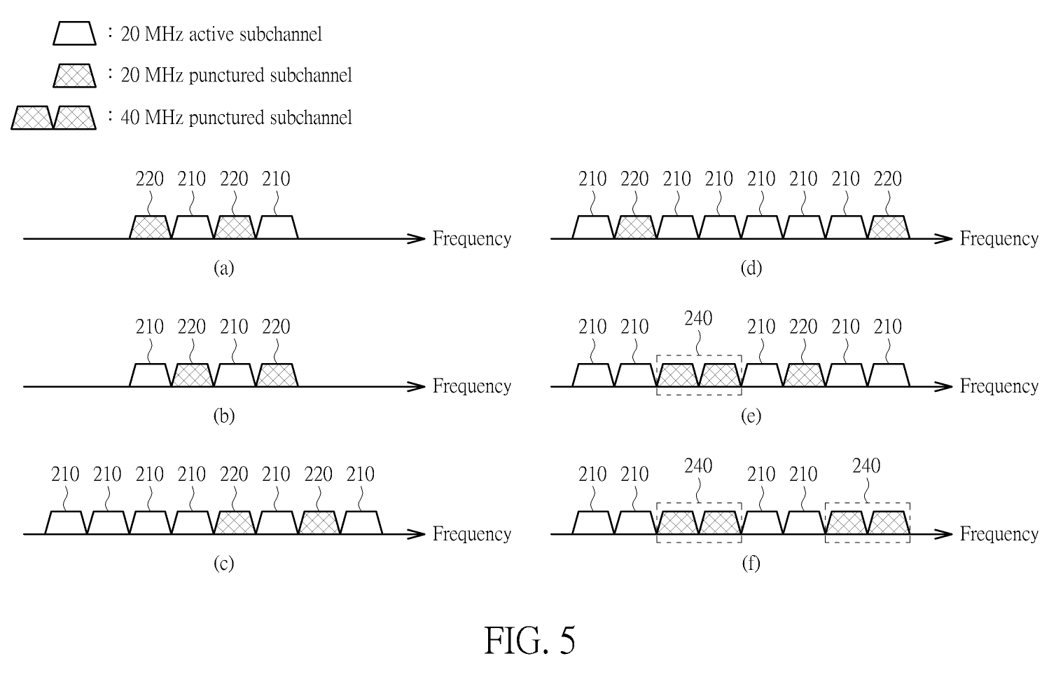

FIG. 5 illustrates enhanced MRU puncturing patterns for channel bandwidths of 80 MHz and 160 MHz with at least two punctured subchannels, according to embodiments of the present disclosure.

For a channel bandwidth of 80 MHz, the at least two punctured subchannels may include two 20 MHz punctured subchannels 220. As depicted in the section (a) of FIG. 5 and the section (b) of FIG. 5, two discrete (non-contiguous) 20 MHz punctured subchannels 220 are located at different positions within the 80 MHz channel bandwidth. These enhanced MRU puncturing patterns may be denoted as "80-20-20" indicating an 80 MHz channel bandwidth with two discrete 20 MHz punctured subchannels. This discrete puncturing pattern enables the wireless communication device to address interference from multiple non-contiguous interference sources while maximizing the usable resource unit capacity.

For a channel bandwidth of 160 MHz, the at least two punctured subchannels may include at least one of: two 20 MHz punctured subchannels 220 (denoted as "160-20-20"), as depicted in the sections (c) and (d) of FIG. 5; one 20 MHz punctured subchannel 220 and one 40 MHz punctured subchannel 240 (denoted as "160-20-40"), as depicted in the section (e) of FIG. 5; or two 40 MHz punctured subchannels 240 (denoted as "160-40-40"), as depicted in the section (f) of FIG. 5. In the embodiment of the sections (c) and (d) of FIG. 5, two discrete 20 MHz punctured subchannels 220 are located at non-contiguous positions within the 160 MHz channel bandwidth (160-20-20 pattern). In the embodiment of the section (e) of FIG. 5, one 20 MHz punctured subchannel 220 and one 40 MHz punctured subchannel 240 are located at different positions within the 160 MHz channel bandwidth (160-20-40 pattern). In the embodiment of the section (f) of FIG. 5, two 40 MHz punctured subchannels 240 are located at non-contiguous positions within the 160 MHz channel bandwidth (160-40-40 pattern).

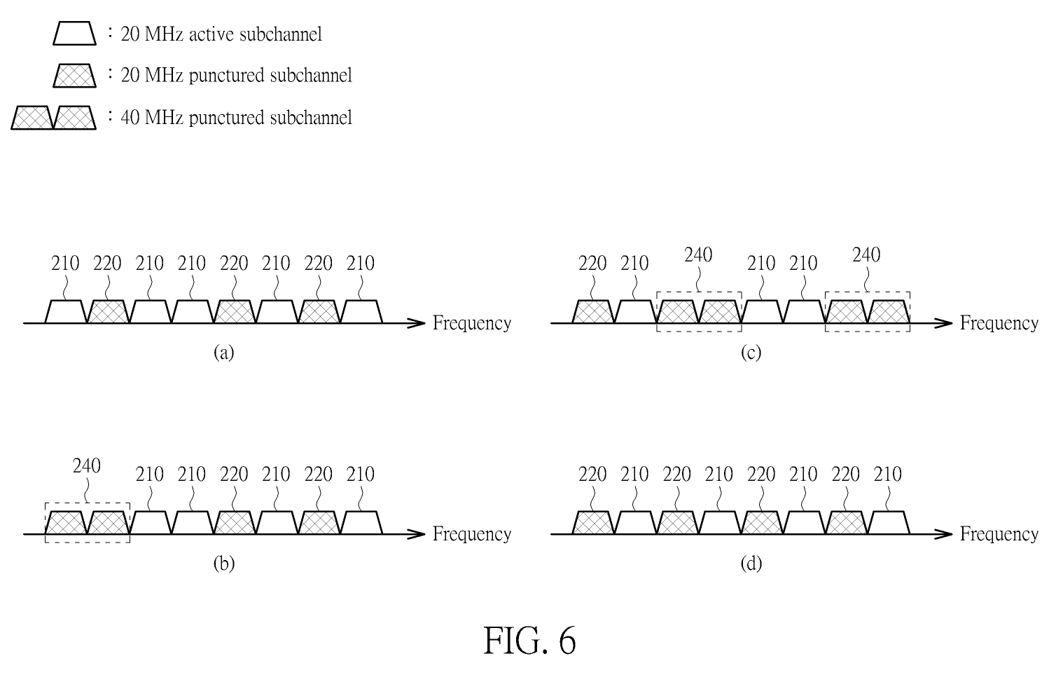

FIG. 6 illustrates enhanced MRU puncturing patterns for a channel bandwidth of 160 MHz with at least three punctured subchannels, according to embodiments of the present disclosure. As depicted in the section (a) of FIG. 6, three 20 MHz punctured subchannels 220 are located at various positions within the 160 MHz channel bandwidth. This enhanced MRU puncturing pattern may be denoted as "160-20-20-20" indicating a 160 MHz channel bandwidth with three discrete 20 MHz punctured subchannels. As depicted in the section (b) of FIG. 6, two 20 MHz punctured subchannels 220 and one 40 MHz punctured subchannel 240 are located within the 160 MHz channel bandwidth. This pattern may be denoted as "160-20-20-40" indicating a 160 MHz channel bandwidth with two 20 MHz punctured subchannels and one 40 MHz punctured subchannel. As depicted in the section (c) of FIG. 6, one 20 MHz punctured subchannel 220 and two 40 MHz punctured subchannels 240 are located within the 160 MHz channel bandwidth. This pattern may be denoted as "160-20-40-40" indicating a 160 MHz channel bandwidth with one 20 MHz punctured subchannel and two 40 MHz punctured subchannels. As depicted in the section (d) of FIG. 6, four 20 MHz punctured subchannels 220 are located at various positions within the 160 MHz channel bandwidth. This pattern may be denoted as "160-20-20-20-20" indicating a 160 MHz channel bandwidth with four discrete 20 MHz punctured subchannels. These enhanced MRU puncturing patterns for the 160 MHz channel bandwidth enable the wireless communication device to address complex interference scenarios involving multiple interference sources at various frequency locations while efficiently allocating the remaining resource units for data transmission.

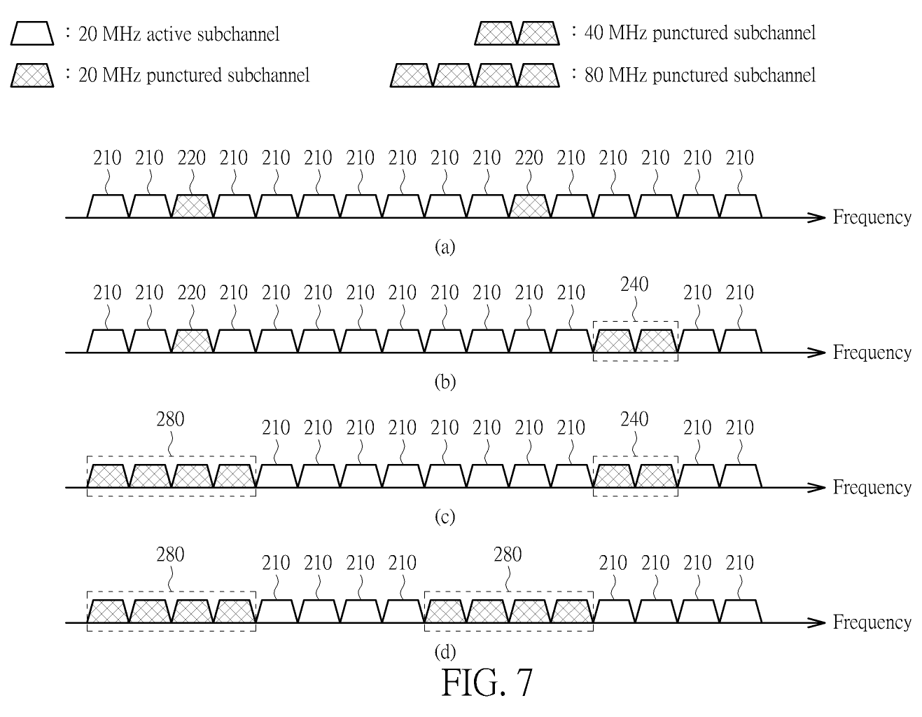

FIG. 7 illustrates enhanced MRU puncturing patterns for a channel bandwidth of 320 MHz with exactly two punctured subchannels, according to embodiments of the present disclosure. The enhanced MRU puncturing patterns for the 320 MHz channel bandwidth with two punctured subchannels include patterns denoted as "320-20-20" (two 20 MHz punctured subchannels), "320-20-40" (one 20 MHz and one 40 MHz punctured subchannel), "320-40-40" (two 40 MHz punctured subchannels), "320-20-80" (one 20 MHz and one 80 MHz punctured subchannel), "320-40-80" (one 40 MHz and one 80 MHz punctured subchannel), and "320-80-80" (two 80 MHz punctured subchannels).

For a channel bandwidth greater than or equal to 320 MHz, the exactly two punctured subchannels having the same bandwidth may include at least one of: two 20 MHz punctured subchannels 220 (320-20-20 pattern), as depicted in the section (a) of FIG. 7; two 40 MHz punctured subchannels 240 (320-40-40 pattern); or two 80 MHz punctured subchannels 280 (320-80-80 pattern), as depicted in the section (d) of FIG. 7.

For a channel bandwidth greater than or equal to 320 MHz, the exactly two punctured subchannels having different bandwidths, wherein one of the exactly two punctured subchannels has a bandwidth of 20 MHz, may include one 20 MHz punctured subchannel 220 and one of: a 40 MHz punctured subchannel 240, as depicted in the section (b) of FIG. 7; or an 80 MHz punctured subchannel 280.

In some embodiments, the exactly two punctured subchannels have bandwidths of 40 MHz and 80 MHz (320-40-80 pattern). As depicted in the section (c) of FIG. 7, one 40 MHz punctured subchannel 240 and one 80 MHz punctured subchannel 280 are located within the 320 MHz channel bandwidth. In existing wireless communication standards such as IEEE 802.11be, the defined puncturing patterns for 320 MHz channel bandwidth with both 40 MHz and 80 MHz puncturing are limited to configurations where the 80 MHz punctured subchannel is located at either the lowest frequency end or the highest frequency end of the channel bandwidth. In contrast, the enhanced MRU puncturing patterns disclosed herein include 320-40-80 patterns where the 80 MHz punctured subchannel 280 is not located at either the lowest frequency end or the highest frequency end of the channel bandwidth. This configuration enables more flexible puncturing to address interference scenarios where an 80 MHz interference source is located in a middle portion of the 320 MHz channel bandwidth rather than at the frequency edges. Additionally, the 40 MHz punctured subchannel 240 is located at a selected 40 MHz subchannel position within the channel bandwidth that does not overlap with the 80 MHz punctured subchannel 280.

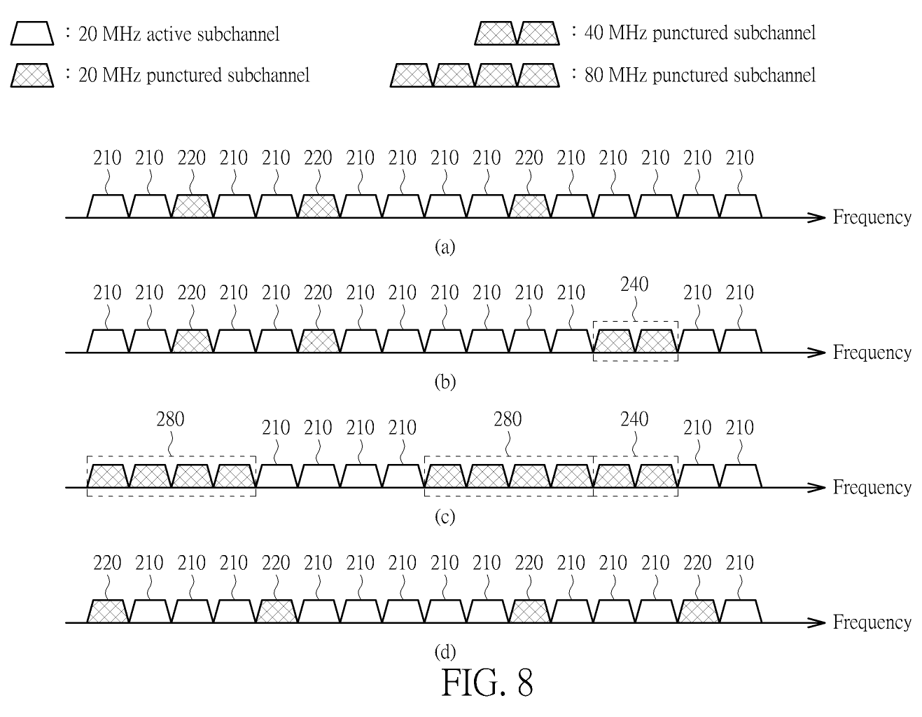

FIG. 8 illustrates enhanced MRU puncturing patterns for a channel bandwidth of 320 MHz with at least three punctured subchannels, according to embodiments of the present disclosure. The enhanced MRU puncturing patterns for the 320 MHz channel bandwidth with three or more punctured subchannels include patterns denoted as "320-20-20-20" (three 20 MHz punctured subchannels), "320-20-20-40" (two 20 MHz and one 40 MHz punctured subchannels), "320-20-20-80" (two 20 MHz and one 80 MHz punctured subchannels), "320-20-40-40" (one 20 MHz and two 40 MHz punctured subchannels), "320-20-40-80" (one 20 MHz, one 40 MHz, and one 80 MHz punctured subchannels), "320-40-40-40" (three 40 MHz punctured subchannels), "320-40-40-80" (two 40 MHz and one 80 MHz punctured subchannels), "320-20-80-80" (one 20 MHz and two 80 MHz punctured subchannels), "320-40-80-80" (one 40 MHz and two 80 MHz punctured subchannels), "320-20-20-20-20" (four 20 MHz punctured subchannels), and additional patterns with more than four punctured subchannels.

For a channel bandwidth greater than or equal to 320 MHz, the at least three punctured subchannels may include at least one of: three 20 MHz punctured subchannels 220 (320-20-20-20 pattern), as depicted in the section (a) of FIG. 8; two 20 MHz punctured subchannels 220 and one 40 MHz punctured subchannel 240 (320-20-20-40 pattern), as depicted in the section (b) of FIG. 8; two 20 MHz punctured subchannels and one 80 MHz punctured subchannel (320-20-20-80 pattern); one 20 MHz punctured subchannel and two 40 MHz punctured subchannels (320-20-40-40 pattern); one 20 MHz punctured subchannel, one 40 MHz punctured subchannel, and one 80 MHz punctured subchannel (320-20-40-80 pattern); three 40 MHz punctured subchannels (320-40-40-40 pattern); two 40 MHz punctured subchannels and one 80 MHz punctured subchannel (320-40-40-80 pattern); one 20 MHz punctured subchannel and two 80 MHz punctured subchannels (320-20-80-80 pattern); one 40 MHz punctured subchannel 240 and two 80 MHz punctured subchannels 280 (320-40-80-80 pattern), as depicted in the section (c) of FIG. 8; or four 20 MHz punctured subchannels 220 (320-20-20-20-20 pattern), as depicted in the section (d) of FIG. 8.

These enhanced MRU puncturing patterns for the 320 MHz channel bandwidth enable the wireless communication device to efficiently utilize spectrum in complex interference environments with multiple interference sources of varying bandwidths. The resulting MRU allocations maximize the available resource unit capacity while avoiding the interference-affected subchannels.

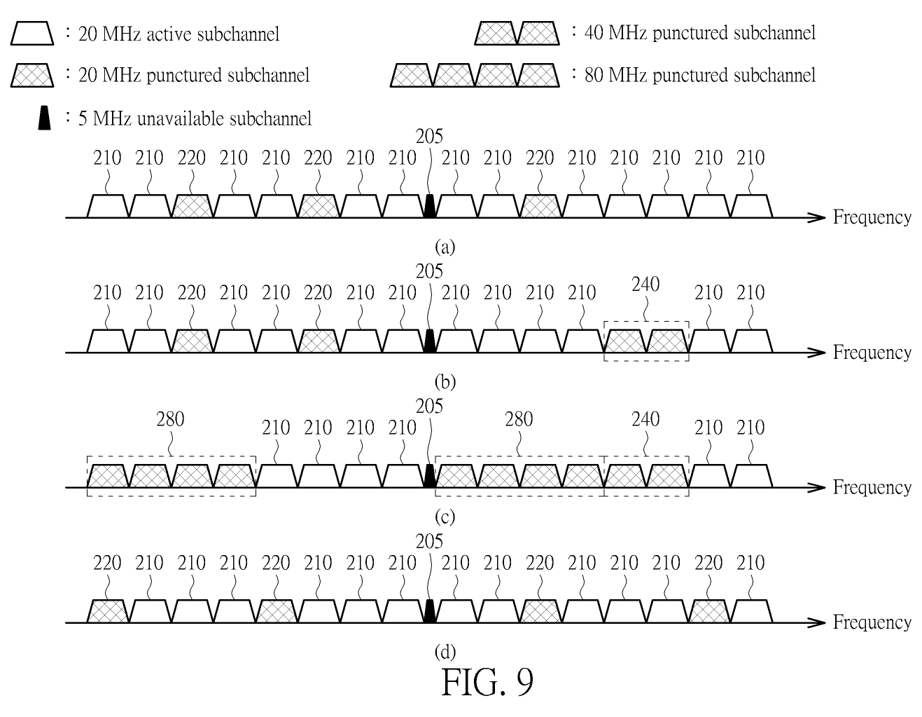

FIG. 9 illustrates enhanced MRU puncturing patterns for a channel bandwidth of 325 MHz in the 5 GHz band, according to embodiments of the present disclosure. In certain regulatory environments, the 5 GHz band may include a 5 MHz unavailable subchannel 205 due to regulatory restrictions. In such cases, the channel bandwidth may be 325 MHz, comprising 320 MHz of usable bandwidth and 5 MHz of unavailable bandwidth. The 5 MHz unavailable subchannel 205 may span from 5730 MHz to 5735 MHz.

As depicted in FIG. 9, the enhanced MRU puncturing patterns described with reference to FIG. 4, FIG. 7 and FIG. 8 may be applied to the 320 MHz usable portion of the 325 MHz channel bandwidth. The 5 MHz unavailable subchannel 205 is excluded from data transmission due to regulatory requirements, and the enhanced MRU puncturing patterns are applied to the remaining 320 MHz bandwidth to address interference sources.

Specifically, the section (a) of FIG. 9 illustrates a 320-20-20-20 pattern (three 20 MHz punctured subchannels 220) applied to the 320 MHz usable portion of the 325 MHz channel bandwidth. The section (b) of FIG. 9 illustrates a 320-20-20-40 pattern (two 20 MHz punctured subchannels 220 and one 40 MHz punctured subchannel 240) applied to the 320 MHz usable portion. The section (c) of FIG. 9 illustrates a 320-40-80-80 pattern (one 40 MHz punctured subchannel 240 and two 80 MHz punctured subchannels 280) applied to the 320 MHz usable portion. The section (d) of FIG. 9 illustrates a 320-20-20-20-20 pattern (four 20 MHz punctured subchannels 220) applied to the 320 MHz usable portion. In each of the sections (a) through (d) of FIG. 9, the 5 MHz unavailable subchannel 205 is shown within the 325 MHz channel bandwidth due to regulatory restrictions applicable to the 5 GHz band.

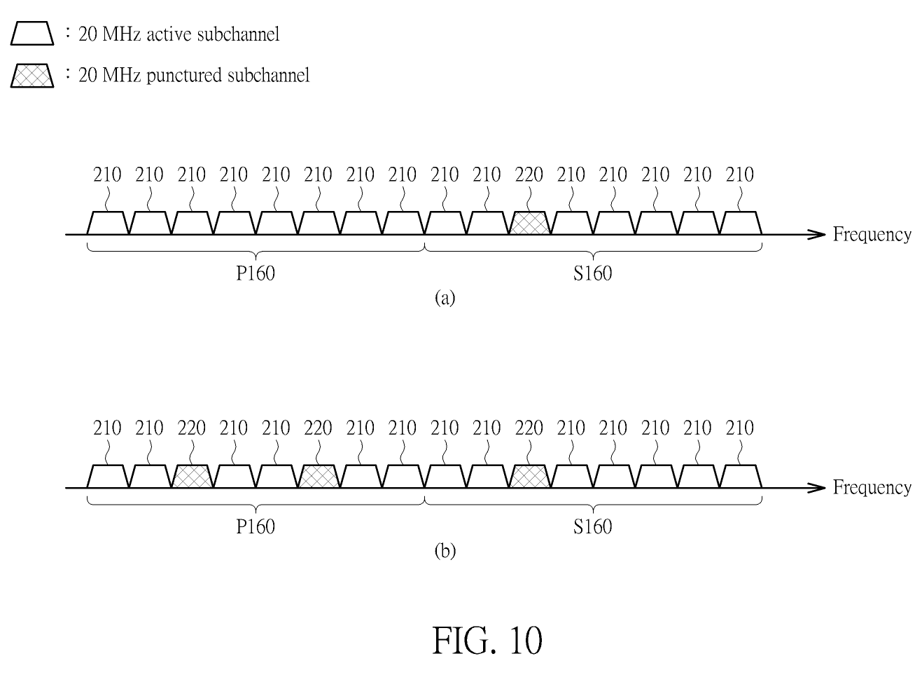

FIG. 10 illustrates enhanced MRU puncturing patterns for a channel bandwidth of 320 MHz showing a primary 160 MHz segment (P160) and a secondary 160 MHz segment (S160), according to embodiments of the present disclosure. The 320 MHz channel bandwidth includes the primary 160 MHz segment P160 and the secondary 160 MHz segment S160.

As depicted in the section (a) of FIG. 10, one 20 MHz punctured subchannel 220 is located within the secondary 160 MHz segment S160, while all subchannels within the primary 160 MHz segment P160 remain active subchannels 210. This configuration may be used when an interference source is detected only in the secondary 160 MHz segment S160.

As depicted in the section (b) of FIG. 10, three 20 MHz punctured subchannels 220 are distributed across both the primary 160 MHz segment P160 and the secondary 160 MHz segment S160. Specifically, one 20 MHz punctured subchannel 220 is located within the primary 160 MHz segment P160, and two 20 MHz punctured subchannels 220 are located within the secondary 160 MHz segment S160. This configuration may be used when interference sources are detected in both the primary 160 MHz segment P160 and the secondary 160 MHz segment S160.

In some embodiments, the wireless communication device may prioritize maintaining active subchannels within the primary 160 MHz segment P160 when selecting an enhanced MRU puncturing pattern. In other embodiments, the wireless communication device may apply puncturing to either or both of the primary 160 MHz segment P160 and the secondary 160 MHz segment S160 based on the location of interference sources.

The enhanced MRU puncturing patterns illustrated in FIG. 10 provide technical advantages over existing puncturing mechanisms. In a first example scenario where a single 20 MHz interference source is present within the 320 MHz channel bandwidth, existing standards such as IEEE 802.11be may require puncturing at 40 MHz granularity for 320 MHz PPDU bandwidth, resulting in a usable data bandwidth of approximately 280 MHz. In contrast, the enhanced MRU puncturing patterns disclosed herein enable puncturing at 20 MHz granularity, resulting in a usable data bandwidth of approximately 300 MHz. This represents a gain of 20 MHz of additional usable bandwidth compared to existing puncturing mechanisms.

In a second example scenario where multiple discrete 20 MHz interference sources are present at non-contiguous positions within the 320 MHz channel bandwidth, existing puncturing mechanisms may require puncturing larger contiguous blocks (e.g., 40 MHz or 80 MHz units) to address each interference source, even when the actual interference affects only 20 MHz subchannels. This results in unnecessary loss of usable bandwidth. In contrast, the enhanced MRU puncturing patterns disclosed herein support discrete puncturing of multiple non-contiguous 20 MHz subchannels, enabling the wireless communication device to puncture only the specific 20 MHz subchannels affected by interference while maximizing the remaining usable bandwidth. For example, when three discrete 20 MHz interference sources are present within the 320 MHz channel bandwidth, the enhanced MRU puncturing patterns can achieve a usable data bandwidth of approximately 260 MHz, compared to approximately 200 MHz achievable with existing puncturing mechanisms that require puncturing at larger granularities. This discrete puncturing capability provides improvements in spectrum utilization efficiency, particularly in complex interference environments with multiple non-contiguous interference sources.

In some embodiments, prior to transmitting or receiving a PPDU with an enhanced MRU puncturing pattern, wireless communication devices may exchange capability information indicating support for the enhanced MRU puncturing pattern. For example, the wireless communication device 100B may transmit capability information to the wireless communication device 100A indicating that the wireless communication device 100B supports the enhanced MRU puncturing patterns described herein. Based on the received capability information, the wireless communication device 100A may determine whether to use an enhanced MRU puncturing pattern for subsequent PPDU transmissions.

In operation, the processing circuit 110A of the wireless communication device 100A determines an enhanced MRU puncturing pattern for transmission. The determination may be based on interference conditions detected by the transceiver 130A, capability information received from the wireless communication device 100B, or other factors.

In some embodiments, the processing circuit 110A may detect interference based on one or more of the following: energy detection on each subchannel, preamble detection indicating the presence of overlapping basic service set (OBSS) transmissions, or information received from other wireless communication devices indicating interference conditions. The processing circuit 110A may maintain an interference map that records the location and characteristics of detected interference sources within the channel bandwidth.

In some embodiments, the processing circuit 110A may dynamically update the selected enhanced MRU puncturing pattern in response to changes in the detected interference. For example, if interference is detected in an additional subchannel, the processing circuit 110A may select a different enhanced MRU puncturing pattern that includes the additional subchannel as a punctured subchannel. Conversely, if interference is no longer detected in a previously punctured subchannel, the processing circuit 110A may select an enhanced MRU puncturing pattern that does not include that subchannel as a punctured subchannel, thereby recovering the bandwidth of that subchannel for data transmission.

In some embodiments, the processing circuit 110A selects the enhanced MRU puncturing pattern from a plurality of candidate patterns based on which candidate pattern provides the highest usable bandwidth while avoiding all detected interference locations. For example, if interference is detected in a 20 MHz subchannel and an adjacent 20 MHz subchannel (forming a contiguous 40 MHz interference region), the processing circuit 110A may select either a pattern with two discrete 20 MHz punctured subchannels or a pattern with one 40 MHz punctured subchannel, depending on which pattern is supported and which pattern maximizes the resulting multi-resource unit (MRU) allocation efficiency.

The wireless communication device 100B receives the PPDU 160 from the wireless communication device 100A via the transceiver 130B, wherein the PPDU 160 is transmitted over a channel bandwidth comprising a plurality of subchannels. The processing circuit 110B extracts the signaling information 172 from the preamble 170 of the PPDU 160. The processing circuit 110B determines, based on the signaling information 172, that an enhanced MRU puncturing pattern is used for the PPDU 160. In some embodiments, the determination is based on at least one validate bit in the U-SIG field 174 having a predetermined value. The processing circuit 110B identifies the enhanced MRU puncturing pattern based on the signaling information 172. In some embodiments, the identification is based on the puncturing pattern information in the U-SIG field 174. In some embodiments, the signaling information 172 is distributed across the U-SIG field 174 and the second signaling field 184. The processing circuit 110B decodes the payload data 190 from the PPDU 160 based on the identified enhanced MRU puncturing pattern.

In some embodiments, the processing circuit 110A of the wireless communication device 100A is further configured to receive a second PPDU from the wireless communication device 100B, extract signaling information from a preamble of the second PPDU, determine, based on the signaling information extracted from the preamble of the second PPDU, whether the second PPDU is associated with a second enhanced MRU puncturing pattern, and decode the second PPDU based on the second enhanced MRU puncturing pattern. This bidirectional capability enables both the wireless communication device 100A and the wireless communication device 100B to transmit and receive PPDUs using enhanced MRU puncturing patterns, providing flexible communication in environments with varying interference conditions.

The configuration of the processing circuits 110A and 110B in combination with the transceivers 130A and 130B as described provides technical improvements including enhanced spectrum utilization efficiency. By supporting puncturing at finer granularity (e.g., 20 MHz units for 320 MHz channel bandwidths), the disclosed embodiments enable wireless communication devices to more efficiently utilize available spectrum when interference affects only a portion of the channel bandwidth. The discrete puncturing patterns described herein enable wireless communication devices to address interference from multiple non-contiguous interference sources, providing technical advantages in complex interference environments such as those with multiple overlapping basic service sets (OBSS). The signaling mechanisms described herein, including the use of validate bits and puncturing pattern information within existing signal field structures, provide efficient indication of enhanced MRU puncturing patterns.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A wireless communication method for transmitting a physical layer protocol data unit (PPDU) with an enhanced multi-resource unit (MRU) puncturing pattern, the wireless communication method comprising:
determining, by a wireless communication device, the enhanced MRU puncturing pattern for transmission, wherein the enhanced MRU puncturing pattern indicates at least one of:
for a channel bandwidth of 80 MHz or 160 MHz, at least two punctured subchannels; or
for a channel bandwidth greater than or equal to 320 MHz, at least one of:
exactly one punctured subchannel having a bandwidth of 20 MHz;
at least two punctured subchannels having a same bandwidth;
exactly two punctured subchannels having different bandwidths, wherein one of the exactly two punctured subchannels has a bandwidth of 20 MHz;
exactly two punctured subchannels having bandwidths of 40 MHz and 80 MHz, wherein the 80 MHz punctured subchannel is not located at either a lowest frequency end or a highest frequency end of the channel bandwidth; or
at least three punctured subchannels;
generating, by the wireless communication device, a preamble of the PPDU, wherein the preamble includes signaling information configured to indicate that the enhanced MRU puncturing pattern is used and to identify the enhanced MRU puncturing pattern; and
transmitting, by the wireless communication device, the PPDU including the preamble to a receiving device.

2. The wireless communication method of claim 1, wherein the signaling information includes a universal signal (U-SIG) field, and the U-SIG field comprises at least one validate bit being set to a predetermined value to indicate that the enhanced MRU puncturing pattern is used.

3. The wireless communication method of claim 2, wherein the at least one validate bit comprises one or more validate bits selected from: bit position B25 of a first U-SIG (U-SIG-1) symbol, bit position B2 of a second U-SIG (U-SIG-2) symbol, and bit position B8 of the second U-SIG (U-SIG-2) symbol.

4. The wireless communication method of claim 2, wherein the U-SIG field further comprises puncturing pattern information configured to identify which of a plurality of enhanced MRU puncturing patterns is used for the PPDU.

5. The wireless communication method of claim 1, wherein for a channel bandwidth of 80 MHz, the at least two punctured subchannels comprise two 20 MHz punctured subchannels; or
for a channel bandwidth of 160 MHz, the at least two punctured subchannels comprise at least one of:
two 20 MHz punctured subchannels;
one 20 MHz punctured subchannel and one 40 MHz punctured subchannel; or
two 40 MHz punctured subchannels.

6. The wireless communication method of claim 1, wherein, for a channel bandwidth greater than or equal to 320 MHz, the exactly two punctured subchannels having different bandwidths comprise one 20 MHz punctured subchannel and one of:
a 40 MHz punctured subchannel; or
an 80 MHz punctured subchannel.

7. The wireless communication method of claim 1, wherein, for a channel bandwidth greater than or equal to 320 MHz, the at least two punctured subchannels having the same bandwidth comprise at least one of:
two 20 MHz punctured subchannels;
two 40 MHz punctured subchannels; or
two 80 MHz punctured subchannels.

8. The wireless communication method of claim 1, wherein, for a channel bandwidth greater than or equal to 320 MHz, the at least three punctured subchannels comprise at least one of:
three 20 MHz punctured subchannels;
two 20 MHz punctured subchannels and one 40 MHz punctured subchannel;
two 20 MHz punctured subchannels and one 80 MHz punctured subchannel;
one 20 MHz punctured subchannel and two 40 MHz punctured subchannels;
one 20 MHz punctured subchannel, one 40 MHz punctured subchannel, and one 80 MHz punctured subchannel;
three 40 MHz punctured subchannels;
two 40 MHz punctured subchannels and one 80 MHz punctured subchannel;
one 20 MHz punctured subchannel and two 80 MHz punctured subchannels;
one 40 MHz punctured subchannel and two 80 MHz punctured subchannels; or
four 20 MHz punctured subchannels.

9. The wireless communication method of claim 1, wherein the signaling information is distributed across a universal signal (U-SIG) field and one of an extremely high throughput signal (EHT-SIG) field or an ultra-high reliability signal (UHR-SIG) field within the preamble.

10. A wireless communication method for receiving a physical layer protocol data unit (PPDU), the wireless communication method comprising:
receiving, by a wireless communication device, the PPDU from a transmitting device, wherein the PPDU is transmitted over a channel bandwidth comprising a plurality of subchannels;
extracting signaling information from a preamble of the PPDU;
determining, based on the signaling information, that an enhanced multi-resource unit (MRU) puncturing pattern is used for the PPDU;
identifying the enhanced MRU puncturing pattern based on the signaling information; and
decoding payload data from the PPDU based on the identified enhanced MRU puncturing pattern.

11. The wireless communication method of claim 10, wherein the enhanced MRU puncturing pattern indicates at least one of:
when the channel bandwidth is 80 MHz or 160 MHz, at least two punctured subchannels; or
when the channel bandwidth is greater than or equal to 320 MHz, at least one of:
exactly one punctured subchannel having a bandwidth of 20 MHz;
at least two punctured subchannels having a same bandwidth;
exactly two punctured subchannels having different bandwidths, wherein one of the exactly two punctured subchannels has a bandwidth of 20 MHz;
exactly two punctured subchannels having bandwidths of 40 MHz and 80 MHz, wherein the 80 MHz punctured subchannel is not located at either a lowest frequency end or a highest frequency end of the channel bandwidth; or
at least three punctured subchannels.

12. The wireless communication method of claim 10, further comprising:
prior to receiving the PPDU, transmitting capability information indicating support for the enhanced MRU puncturing pattern to the transmitting device.

13. The wireless communication method of claim 10, wherein the signaling information includes a universal signal (U-SIG) field, and wherein determining that the enhanced MRU puncturing pattern is used is based on at least one validate bit in the U-SIG field having a predetermined value.

14. The wireless communication method of claim 13, wherein the at least one validate bit comprises one or more validate bits selected from: bit position B25 of a first U-SIG (U-SIG-1) symbol, bit position B2 of a second U-SIG (U-SIG-2) symbol, and bit position B8 of the second U-SIG (U-SIG-2) symbol.

15. The wireless communication method of claim 13, wherein the U-SIG field further comprises puncturing pattern information, and wherein identifying the enhanced MRU puncturing pattern is based on the puncturing pattern information.

16. The wireless communication method of claim 10, wherein the signaling information is distributed across a universal signal (U-SIG) field and one of an extremely high throughput signal (EHT-SIG) field or an ultra-high reliability signal (UHR-SIG) field within the preamble.

17. A wireless communication device, the wireless communication device comprising:
a transceiver configured to transmit and receive physical layer protocol data units (PPDUs) over a wireless channel; and
a processor coupled to the transceiver, the processor configured to:
determine an enhanced multi-resource unit (MRU) puncturing pattern for transmission, wherein the enhanced MRU puncturing pattern indicates at least one of:
for a channel bandwidth of 80 MHz or 160 MHz, at least two punctured subchannels; or
for a channel bandwidth greater than or equal to 320 MHz, at least one of:
exactly one punctured subchannel having a bandwidth of 20 MHz;
at least two punctured subchannels having a same bandwidth;
exactly two punctured subchannels having different bandwidths, wherein one of the exactly two punctured subchannels has a bandwidth of 20 MHz;
exactly two punctured subchannels having bandwidths of 40 MHz and 80 MHz, wherein the 80 MHz punctured subchannel is not located at either a lowest frequency end or a highest frequency end of the channel bandwidth; or
at least three punctured subchannels;
generate a preamble for inclusion in a PPDU, the preamble including signaling information configured to indicate that the enhanced MRU puncturing pattern is used and to identify the enhanced MRU puncturing pattern; and
control the transceiver to transmit the PPDU including the preamble.

18. The wireless communication device of claim 17, wherein the processor is further configured to:
receive a second PPDU from a second wireless communication device;
extract signaling information from a preamble of the second PPDU;
determine, based on the signaling information extracted from the preamble of the second PPDU, whether the second PPDU is associated with a second enhanced MRU puncturing pattern; and
decode the second PPDU based on the second enhanced MRU puncturing pattern.

19. The wireless communication device of claim 17, wherein the processor is further configured to:
detect interference in at least one subchannel of a channel bandwidth; and
select the enhanced MRU puncturing pattern such that the punctured subchannels indicated by the enhanced MRU puncturing pattern correspond to a location of the detected interference.
